(19) United States
(12) Patent Application Publication
(10) Pub. No.: US 2021/0399094 A1
(43) Pub. Date: Dec. 23, 2021

(54) ELECTRONIC SECURITY COMPONENT

(71) Applicant: STMicroelectronics (Crolles 2) SAS, Crolles (FR)

(72) Inventor: Benoit FROMENT, Grenoble (FR)

(73) Assignee: STMicroelectronics (Crolles 2) SAS, Crolles (FR)

(21) Appl. No.: 17/352,535

(22) Filed: Jun. 21, 2021

(30) Foreign Application Priority Data
Jun. 22, 2020 (FR) 2006494

(51) Int. Cl. H01L 29/08; H01L 23/58; G06F 21/79

(52) U.S. Cl. CPC H01L 29/0843; G06F 21/79; H01L 23/58

(57) ABSTRACT

An electronic component is formed on and in a semiconductor substrate. The component includes source and drain regions and a gate region between the source and drain regions. Two dielectric lateral spacing regions are provided on the semiconductor substrate against sides of the gate region. An electrical connection, formed by a silicide on a surface of at least one of said dielectric lateral spacing region, is configured to electrically connect the gate region to at least one of the source region and the drain region.

### PRIORITY CLAIM

This application claims the priority benefit of French Application for Patent No. 2006494, filed on Jun. 22, 2020, the content of which is hereby incorporated by reference in its entirety to the maximum extent allowable by law.

### TECHNICAL FIELD

Embodiments and implementations relate to semiconductor components that can be used in particular to secure integrated circuits.

### BACKGROUND

Integrated circuit securing involves improving the security of an integrated circuit in a way that makes it difficult, or even impossible, for an unauthorized person to access data or functions that can be implemented by the integrated circuit.

For example, physical unclonable function (PUF) devices are known which are used to authenticate integrated circuits and generate cryptographic keys. In particular, physical unclonable function devices are based on the variability of the intrinsic features of the components of integrated circuits which can be obtained by the same manufacturing method. The variability of the intrinsic features can then be used to generate different digital words for each integrated circuit.

A completely different security solution utilizes leakage currents for a slow discharge of at least one electronic component of the integrated circuit. Such a solution is, for example, used for integrated circuits using a code to be entered in order to authorize access to the functions and/or to the data of these integrated circuits. In particular, the use of this discharge solution can be used to limit the number of code entry attempts by allowing a blocking of the integrated circuit after the electronic components are discharged.

Another security solution utilizes false electronic components in an integrated circuit. The use of false electronic components makes it harder for a third party to reverse engineer the integrated circuit.

The electronic components used for such applications can have a complex structure, and be difficult and expensive to manufacture.

There is accordingly a need in the art to provide an electronic component with a simple structure that can be easily manufactured.

There is also a need to provide a method for manufacturing such an electronic component.

### SUMMARY

According to one aspect, a method for manufacturing an electronic component comprises: forming source and drain regions in and/or on a semiconductor substrate; forming a gate region on the semiconductor substrate between the source and drain regions; forming two dielectric lateral spacing regions on the semiconductor substrate against said gate region; and forming an electrical connection on the surface of at least one of said dielectric lateral spacing regions to electrically connect the gate region to the source region and/or electrically connect the gate region to the drain region.

The electronic component that can be obtained by such a method therefore comprises an electrical connection allowing to electrically connect the gate region to the source region and/or to the drain region.

In particular, the electronic component may comprise a single electrical connection linking the gate region to the drain region, or else a single electrical connection linking the gate region to the source region. Alternatively, the electronic component may comprise two electrical connections, a first electrical connection linking the gate region to the drain region and a second electrical connection linking the gate region to the source region.

Thus, according to another aspect, an electronic component is proposed comprising: a semiconductor substrate; source and drain regions formed in and/or on the semiconductor substrate; a gate region on the semiconductor substrate between the source and drain regions; two dielectric lateral spacing regions on the semiconductor substrate against the gate region; an electrical connection on the surface of at least one of said dielectric lateral spacing regions that electrically connects the gate region to the source region and/or electrically connects the gate region to the drain region.

Such an electronic component can therefore be obtained by the manufacturing method described above.

Each electrical connection enables a leakage current between the gate region and the source region and/or the drain region to which this electrical connection is linked.

Each electrical connection also has its own resistance.

Such an electronic component can be used for various applications for securing an integrated circuit.

In particular, the proposed electronic component can be used to produce a physical unclonable function device as described below.

Alternatively, the proposed electronic component can be used in applications for which a slow discharge of an integrated circuit component must be implemented. The leakage current permitted by the electrical connection then supports performing the discharge.

The proposed electronic component can also be used to form a false transistor. Indeed, the proposed electronic component has a structure which differs from a transistor only by its electrical connection between the gate region to the source region and/or to the drain region. However, the electrical connection is difficult to detect. Thus, a third party may think that the electronic component is a real transistor.

Furthermore, the proposed method for manufacturing such an electronic component is simple and inexpensive to implement.

In an advantageous implementation, the formation of said electrical connection comprises: ion implantation in at least one of said two dielectric lateral spacing regions; and silicidation (or salicide) by a metal layer, the silicidation allowing to form, by reaction of said metal with the implanted ions, said electrical connection to electrically connect the gate region (RGC) to the source region and/or to the drain region.

In an advantageous implementation, the silicidation comprises a deposition of said metal layer on the source, drain and gate regions as well as on the two dielectric lateral spacing regions.

In an advantageous implementation, the silicidation comprises a first heating after said deposition of the metal layer so as to make the metal layer react with the source, drain and gate regions as well as with the ions implanted in at least one of said dielectric lateral spacing regions.

In particular, the first heating also allows to diffuse the metal of said metal layer into the semiconductor substrate.

In an advantageous implementation, the silicidation comprises a removal of said metal layer after the first heating.

Removing the metal layer allows to take off the metal layer without removing the metal obtained by the metal layer that has reacted with the implanted ions.

In an advantageous implementation, the silicidation comprises a second heating after the removal of said metal layer, at a temperature above a temperature used for the first heating.

The temperature of the first heating can then be selected to reduce a risk of obtaining a narrow line effect.

In particular, in an advantageous implementation, during the first heating, the electronic component is heated to a temperature of the order of 300° C.

In an advantageous implementation, during the second heating, the electronic component is heated to a temperature of the order of 400° C.

In an advantageous implementation, the nature of the ions for said implantation is selected according to the nature of the metal layer deposited during said silicidation.

In an advantageous implementation, the metal layer deposited during the silicidation is made of nickel and the ions implanted during said implantation are silicon ions.

The first heating can then allow to obtain a NiₓSi phase on the surface of at least one dielectric lateral spacing region by reaction of the silicon ions with the nickel of the metal layer. The second heating can then allow a transformation of this NiₓSi phase into NiSi alloy forming said electrical connection of the electronic component.

An ion implantation level is selected according to the desired leakage current obtained by the electrical connection. The desired leakage current varies depending on the application for which the electronic component is intended.

In an advantageous implementation, the implantation is carried out so as to implant a dose of approximately 5×10¹³ ions/cm² in said at least one dielectric lateral spacing region. An electronic component obtained from such an ion implantation has a relatively low leakage current, in particular less than 10 nA. Furthermore, the resistance of the electrical connection of several electronic components manufactured according to this same manufacturing method is variable between these electronic components. Such an electronic component can thus be used to produce a physical unclonable function device, as will be detailed below.

In an advantageous implementation, the implantation is carried out so as to implant approximately 2×10¹⁴ ions/cm² in said at least one dielectric lateral spacing region. An electronic component obtained from such an ion implantation can be used for a slow discharge application of an integrated circuit component. In particular, the leakage current of the electrical connection of the electronic component is then a little greater, in particular comprised between 1 pA and 1 μA and, for example, of the order of 100 pA.

In an advantageous implementation, the implantation is carried out so as to implant 5×10¹⁵ ions/cm² in said at least one dielectric lateral spacing region. An electronic component obtained from such an ion implantation can be used as a false transistor. The electrical connection then short-circuits the electronic component.

According to another aspect, a method for manufacturing an integrated circuit comprises: manufacturing at least one electronic component using the manufacturing method as described above; and manufacturing at least one transistor comprising: forming source and drain regions in the semiconductor substrate and a gate region on the semiconductor substrate between the source and drain regions, this formation being carried out simultaneously with the formation of the source, drain and gate regions for manufacturing said at least one electronic component; forming two dielectric lateral spacing regions on the semiconductor substrate against said gate region, this formation being carried out simultaneously with the formation of the dielectric lateral spacing regions for manufacturing said at least one electronic component; and forming a protection on said at least one transistor to prevent the formation of an electrical connection on the surface of the dielectric lateral spacing regions of this transistor during the formation of the electrical connection of said at least one electronic component.

In an advantageous implementation, the manufacture of at least one transistor comprises: forming a mask providing said protection on said at least one transistor before implanting the ions for manufacturing said at least one electronic component so as to protect said at least one transistor during ion implantation; removing the mask after said ion implantation; carrying out a silicidation simultaneously with the silicidation for manufacturing said at least one electronic component.

The mask protects said at least one transistor during ion implantation.

Thus, according to this implementation, it is possible to pool several steps of manufacturing at least one transistor and at least one electronic component as proposed above. Thus, the manufacture of an electronic component as proposed requires only one additional step compared to the manufacture of a transistor. This additional step is the step of implanting ions on the surface of at least one dielectric lateral spacing region of the electronic component.

According to another aspect, provision is made of an integrated circuit comprising at least one electronic component as described above.

In an advantageous implementation, the integrated circuit also comprises MOS transistors.

In an advantageous embodiment, the integrated circuit comprises: a plurality of electronic components as described above, said at least one electrical connection of each electronic component having its own resistance; a resistance measuring circuit configured to measure the resistance of said at least one electrical connection of each electronic component; a comparison circuit configured to compare the measured resistance of said at least one electrical connection of each electronic component with a reference resistance; and a generation circuit configured to generate a digital word from the results of the comparisons made by the comparison circuit.

### BRIEF DESCRIPTION OF THE DRAWINGS

Other advantages and features of the invention will become apparent upon examining the detailed description of implementations and embodiments, which are in no way limiting, and of the appended drawings wherein:

FIG. 1 illustrates a sectional view of an integrated circuit;

FIG. 2 is a sequential diagram of a method for manufacturing an integrated circuit;

FIGS. 3 to 11 show the results of the various steps implemented in the manufacturing method of FIG. 2; and

FIG. 12 illustrates an integrated physical unclonable function device.

### DETAILED DESCRIPTION

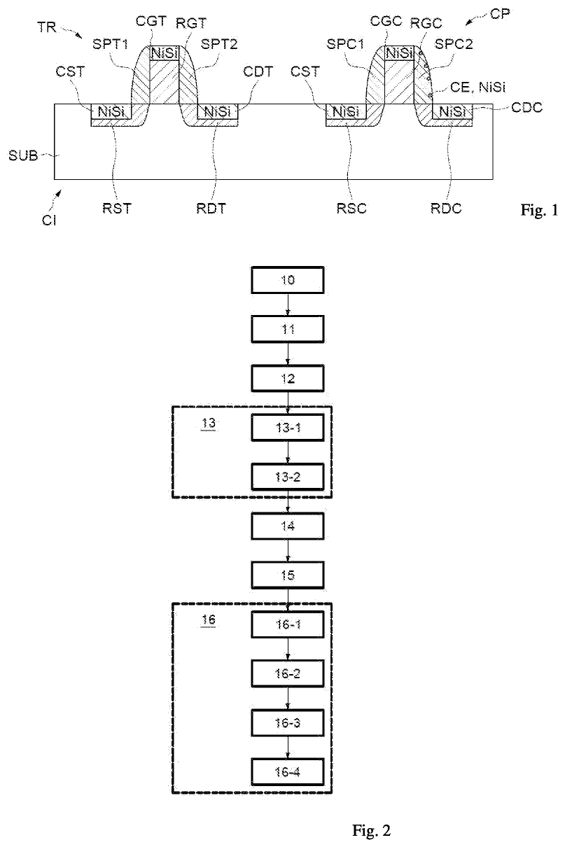

FIG. 1 illustrates a sectional view of an integrated circuit CI according to one embodiment.

The integrated circuit CI comprises at least one transistor TR and at least one electronic component CP according to one embodiment.

In particular, said at least one transistor TR can be a MOS transistor.

In FIG. 1, a single transistor TR and a single electronic component CP are shown for understanding purposes. Nevertheless, it is possible to provide an integrated circuit having several transistors and several electronic components.

In particular, each transistor TR comprises a drain region RDT and a source region RST formed in a semiconductor substrate SUB, in particular in the form of a planar layer. Each transistor TR also comprises a gate region RGT formed on the semiconductor substrate SUB between the drain RDT and source RST regions of this transistor TR. Although not specifically illustrated, the gate region RGT is insulated from the substrate SUB by an insulating layer (such as a gate oxide layer).

Each transistor TR also comprises two dielectric lateral spacing regions SPT1, SPT2 (also known to the person skilled in the art by the name “spacer” or “sidewall spacer”). The dielectric lateral spacing regions SPT1, SPT2 of each transistor TR are disposed against lateral sides of the gate region RGT of this transistor TR. These dielectric lateral spacing regions SPT1, SPT2 can be formed by silicon nitride.

Each transistor TR further comprises contacts CDT, CST and CGT formed respectively on the drain RDT, source RST and gate RGT regions of this transistor TR.

Likewise, each electronic component CP comprises a drain region RDC and a source region RSC formed in the semiconductor substrate SUB. Each electronic component CP also comprises a gate region RGC formed on the semiconductor substrate SUB between the drain RDC and source RSC regions of this electronic component CP. Although not specifically illustrated, the gate region RGC is insulated from the substrate SUB by an insulating layer (such as a gate oxide layer).

Furthermore, each electronic component CP also comprises two dielectric lateral spacing regions (spacers) SPC1, SPC2. The dielectric lateral spacing regions SPC1, SPC2 of each electronic component CP are disposed against lateral sides of the gate region RGC of this electronic component CP. These dielectric lateral spacing regions SPC1, SPC2 can be formed by silicon nitride.

Each electronic component CP further comprises contacts CDC, CSC, CGC formed respectively on the drain RDC, source RSC and gate RGC regions of this electronic component CP.

Each electronic component CP differs from a transistor TR in that it comprises at least one electrical connection CE configured to connect the gate region RGC to one or the other or both of the source region RSC and the drain region RDC.

This electrical connection CE is formed on the surface of at least one dielectric lateral spacing region SPC1, SPC2.

Preferably, this electrical connection CE is formed from a NiSi alloy. Nevertheless, alternatively, the electrical connection CE can be formed from an alloy of NiPtSi, CoSi, TiSi or for example NiGe, NiPtGe.

In particular, the electronic component CP may comprise a single electrical connection CE linking the gate region to the drain region, as shown in FIG. 1, or else a single electrical connection CE linking the gate region RGC to the source region RSC. This electrical connection CE is then formed on the surface of a single dielectric lateral spacing region SPC1, SPC2.

Alternatively, the electronic component may comprise two electrical connections CE, a first electrical connection linking the gate region RGC to the drain region RDC and a second electrical connection linking the gate region RGC to the source region RSC. These electrical connections CE are then formed on the surfaces of the two dielectric lateral spacing regions SPC1, SPC2.

Each electrical connection CE enables a leakage current to flow between the gate region RGC and the source region RSC and/or between the gate region RGC and the drain region RDC to which this electrical connection CE is linked.

Each electrical connection CE also has its own resistance.

Such an electronic component CP can be used for various applications for securing an integrated circuit CI depending on the leakage current that can be obtained by the electrical connection CE of this electronic component CP, as will be described below.

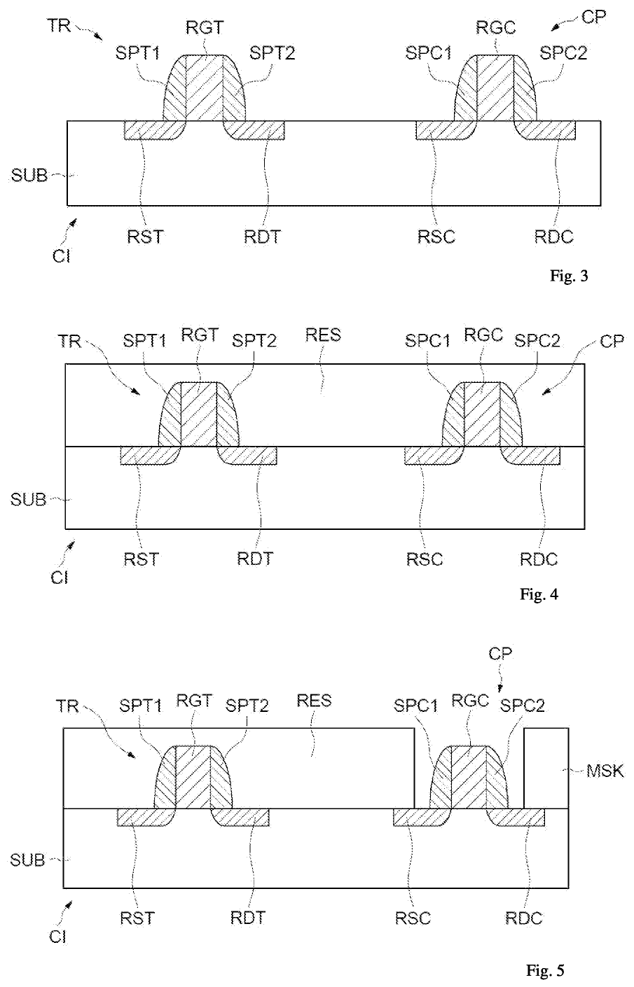

FIG. 2 shows a sequential diagram of a method for manufacturing an integrated circuit according to an embodiment. FIGS. 3 to 11 show the results of the various steps implemented in this manufacturing method.

The manufacturing method supports the manufacture of an integrated circuit as described above for FIG. 1. The manufacturing method thus supports the manufacture of an integrated circuit CI comprising at least one electronic component CP according to one implementation and at least one transistor TR, in particular at least one MOS transistor.

In particular, as will be described below, some steps of the manufacturing method are common for manufacturing each electronic component CP and each transistor TR. This permits a reduction in the number of steps required to manufacture the integrated circuit IC and supports reducing the cost of implementing the manufacturing method.

Thus, the method also comprises a step 10 wherein the gate region RGT, RGC of each transistor and of each electronic component is formed on a semiconductor substrate SUB. This includes the formation of a conductive gate and its associated insulating gate oxide layer.

The method comprises a step 11 wherein the source RST, RSC and drain RDT, RDC regions of each transistor TR and of each electronic component CP are formed in the semiconductor substrate SUB. In particular, the source RST, RSC and drain RDT, RDC regions of each transistor TR and of each electronic component CP are formed so that the gate region RGT, RGC of each transistor and of each electronic component is respectively disposed between the drain and source regions of this transistor and of this electronic component.

The method further comprises a step 12 wherein two dielectric lateral spacing regions SPT1, SPT2 and SPC1, SPC2 are formed on the semiconductor substrate SUB against the sides of the gate region RGT, RGC of each transistor TR and of each electronic component CP.

Steps 10 to 12 are well known to the person skilled in the art for forming transistors and will therefore not be further detailed here.

The result of these various steps is shown in FIG. 3.

The method then comprises a step 13 of forming a mask MSK allowing to protect each transistor TR during an ion implantation step 14 necessary to form said electrical connection CE of each electronic component CP. This ion implantation step 14 will be described in more detail below.

In order to form the mask, step 13 comprises forming (step 13-1) a planarized photosensitive resin RES layer on the integrated circuit CI. The result of this step is shown in FIG. 4.

Then, step 13 comprises removing (step 13-2) a portion of the planarized photosensitive resin RES layer on top of each electronic component CP. The removal of the portion of the planarized photosensitive resin RES on top of each electronic component CP can be accomplished by first exposing each portion of the planarized photosensitive resin RES covering each electronic component CP to light radiation. Then, a chemical developer is used to remove the portion of planarized photosensitive resin RES on top of each electronic component CP. The remaining planarized resin layer RES then forms the mask MSK, as shown in FIG. 5.

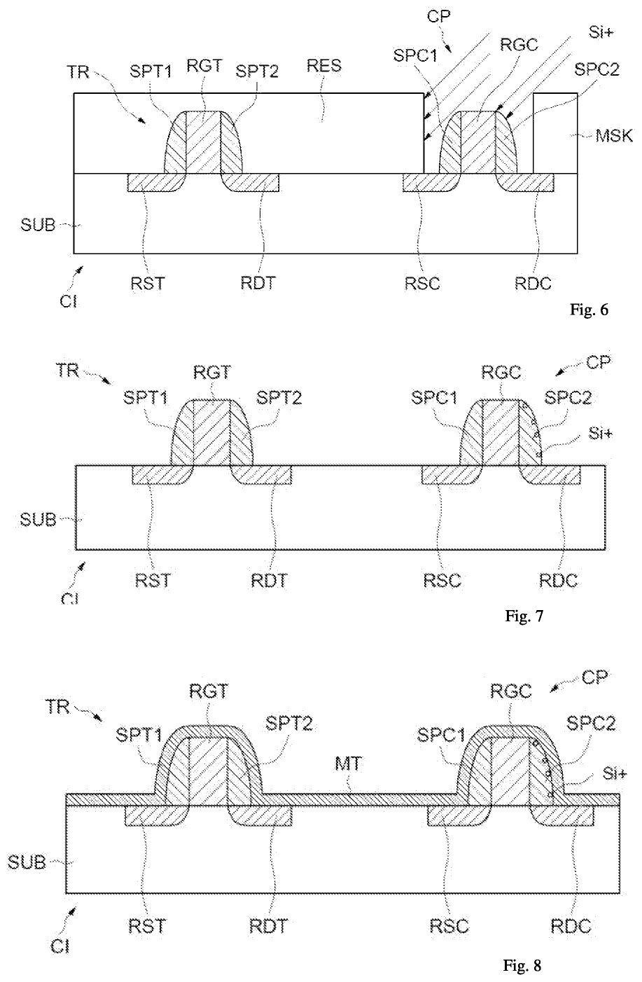

Then, in order to allow the manufacture of the electrical connection CE, the method comprises an ion implantation step 14 wherein ions are implanted in at least one of the dielectric lateral spacing regions SPC1, SPC2 of each electronic component CP. The remaining planarized resin layer RES of the mask MSK protects each transistor TR during this ion implantation step. This step is shown in FIG. 6.

The ion implantation is preferably carried out at an angle selected in particular according to the dielectric lateral spacing regions wherein the ions are to be implanted.

In particular, an ion implantation angle selected between −50° and 0° relative to a vertical axis allows ions to be implanted in the dielectric lateral spacing region SPC1 of each electronic component.

Furthermore, an ion implantation angle selected between 0° and +50° relative to a vertical axis allows ions to be implanted in the dielectric lateral spacing region SPC2 of each electronic component.

An ion implantation angle selected between −50° and +50° relative to a vertical axis allows ions to be implanted in each dielectric lateral spacing region SPC1, SPC2 of each electronic component CP.

The implanted ions are, for example, silicon ions Si+, as shown in FIG. 6. Nevertheless, alternatively, it is possible to implant any type of ion reacting with a metal layer MT used for a silicidation step, as will be described below. For example, when the metal layer used for silicidation is a nickel layer, it is possible to implant germanium ions because the germanium ions react with the nickel.

Then, the method comprises a step 15 wherein the remaining planarized resin layer RES is removed. The result of this step 15 is shown in FIG. 7. The removal of the remaining planarized resin layer can be carried out as described previously. The following steps of the manufacturing method are then common for each transistor TR and each electronic component CP.

The method then comprises a step 16, wherein a silicidation is carried out. This silicidation forms contacts CDT, CST, CGT respectively on the drain RDT, source RST and gate RGT regions of each transistor TR, as well as forms contacts CDC, CSC, CGC respectively on the drain RDC, source RSC and gate RGC regions of each electronic component CP. The silicidation also forms said electrical connection CE of each electronic component CP.

In particular, the silicidation comprises a deposition (step 16-1) of a metal layer MT on the integrated circuit CI, in particular on the source RST, RSC, drain RDT, RDC and gate RGT, RGC regions of each transistor TR and of each electronic component CP, as well as on the dielectric lateral spacing regions SPT1, SPT2, SPC1, SPC2 of each transistor TR and of each electronic component CP. Preferably, the metal layer MT used is a nickel layer. Nevertheless, alternatively, it is also possible to provide for using a layer of Ti, Co, Yb, Pt, Ni(Pt), Ru. The result of this deposition is shown in FIG. 8.

The silicidation then comprises a first heating (step 16-2) of the integrated circuit CI and of the metal layer MT. During this first heating step 16-2, the integrated circuit CI and the metal layer MT are heated to a temperature comprised between 240° C. and 350° C., in particular of the order of 300° C. Such a temperature enables the diffusion of the metal MT into the source RST, RSC, drain RDT, RDC and gate RGT, RGC regions of each transistor TR and of each electronic component CP. The metal MT can then react with source RST, RSC, drain RDT, RDC and gate RGT, RGC regions to manufacture the contacts CST, CSC, CDT, CDC, CGT and CGC. In particular, when the metal layer MT is made of nickel and the semiconductor substrate SUB is made of silicon, the first heating creates a NiₓSi phase, with x greater than or equal to 1, on the surface of the source RST, RSC, drain RDT, RDC and gate RGT, RGC regions.

Such a temperature also supports the diffusion of the metal MT on the surface of the dielectric lateral spacing regions SPC1, SPC2. The metal can then react with the ions implanted in these dielectric lateral spacing regions SPC1, SPC2.

In particular, the nickel layer MT is configured to react with the implanted silicon ions so as to obtain a NiₓSi phase.

Furthermore, the temperature of the first heating step 16-2 is configured to reduce a risk of obtaining a narrow line effect.

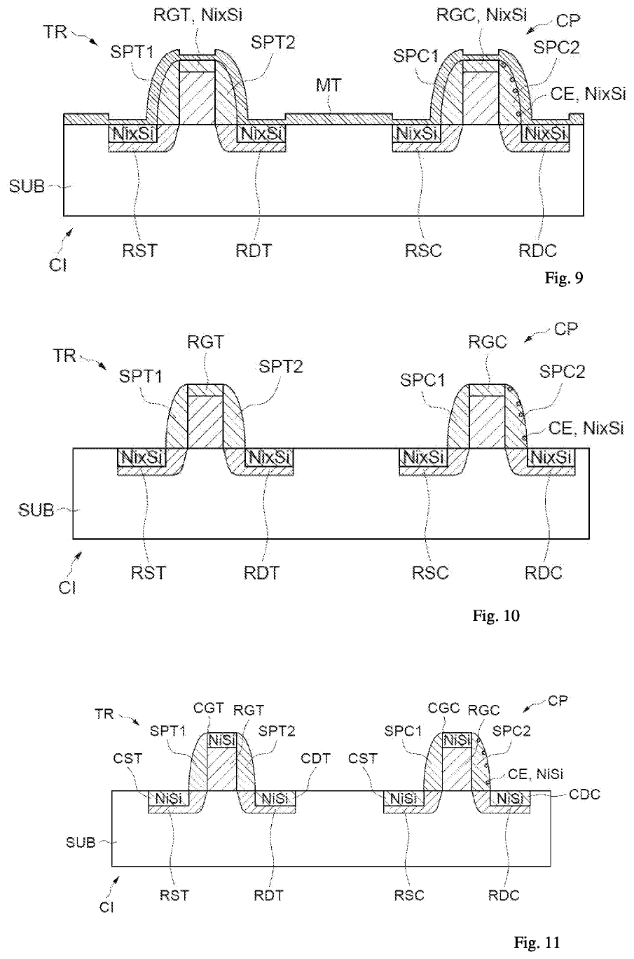

The result of this first heating is shown in FIG. 9.

The silicidation step 16 then comprises a removal (step 16-3) of the metal layer MT by a selective wet etching method. The removal step 16-3 of the metal layer allows the metal layer MT to be taken off without removing the metal reacted with the implanted ions. In particular, the removal is carried out using a mixture of sulfuric acid (H₂SO₄) and hydrogen peroxide (H₂O₂). The result of this removal step 16-3 is shown in FIG. 10.

The silicidation step 16 then comprises a second heating (step 16-4) to a temperature above the temperature used for the first heating. In particular, during the second heating, the integrated circuit is heated to a temperature comprised between 360° C. and 450° C., in particular of the order of 400° C.

The second heating step 16-4 causes a modification of the areas having a NiₓSi phase into a NiSi alloy. This NiSi alloy then forms the contacts CDT, CDC, CST, CSC, CGT, CSC on top of the drain RDT, RDC, source RST, RSC and gate RGT, RGC regions of each transistor TR and of each electronic component CP, as well as the electrical connection CE of each electronic component CP.

Thus, once this second heating step 16-4 has been completed, each transistor TR and each electronic component CP are obtained, as shown in FIG. 11.

In such a method, the steps of manufacturing a transistor TR are commonly carried out with some steps of manufacturing an electronic component CP. By performing these steps together, it is possible to optimize the method for manufacturing each transistor TR and each electronic component CP. In particular, because of these common manufacturing steps between the manufacture of a transistor TR and that of an electronic component CP, the manufacture of an electronic component CO requires only one additional step compared to the manufacture of a transistor TR. This additional step is the step 14 of implanting ions on the surface of at least one dielectric lateral spacing region. A mask is nevertheless also applied to each transistor TR to protect them during this ion implantation step 14.

Nevertheless, alternatively, it is possible to manufacture each electronic component CP separately in isolation from the transistors TR, for example by first forming each electronic component CP then forming the transistors TR (or vice versa).

Moreover, as indicated above, the electronic component CP can be intended for various applications for securing an integrated circuit CI. In particular, the leakage current resulting from the electrical connection CE of the electronic component CP is selected according to the selected application of the electronic component CP.

The leakage current of the electrical connection CE depends on its own resistance. However, the resistance of the electrical connection CE depends on the number of ions implanted in the dielectric lateral spacing regions SPC1, SPC2. Thus, the number of ions to be implanted in the dielectric lateral spacing regions SPC1, SPC2 depends on the selected application of the electronic component.

In particular, the number of ions to be implanted can be selected in order to be able to obtain an electronic component CP which can be used as a false transistor. The number of ions to be implanted is then selected to allow to obtain an electronic component CP having enough electrical connection to form a short circuit.

For example, the implantation is carried out so as to implant 5×10¹⁵ ions/cm².

The electrical connection CE obtained is difficult to be detected. Thus, it is difficult for a third party to determine whether the electronic component CP is a transistor TR or not, due to the similar structure between the electronic component CP and a transistor TR. It is then difficult for this third party to reverse engineer the integrated circuit IC.

Moreover, the number of ions to be implanted can be selected in order to be able to obtain an electronic component CP which can be used for a slow discharge application. The leakage current permitted by the electrical connection CE then allows for a slow discharge to occur.

For example, the implantation can be carried out so as to implant 2×10¹⁴ ions/cm². The leakage current of the electronic component CP is, in particular, comprised between 1 pA and 1 μA, for example of the order of 100 pA. The leakage current can therefore be used for a slow discharge.

Moreover, the number of ions to be implanted can be selected in order to be able to obtain an electronic component CP which can be used in an integrated physical unclonable function device DI.

For example, the implantation is carried out so as to implant 5×10¹³ ions/cm². Such an ion implantation can produce an electronic component having a relatively low leakage current, in particular less than 10 nA.

The resistance of the electrical connection CE of several electronic components CP manufactured according to this same manufacturing method is variable according to these electronic components CP. It is then possible to use this variability of the resistance of the electrical connection CE of the electronic components CP in an integrated physical unclonable function device DI.

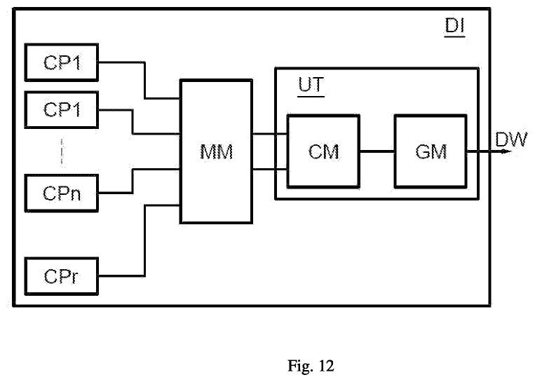

More particularly, FIG. 12 illustrates an integrated physical unclonable function device DI. This integrated device DI comprises a plurality of electronic components CP1, . . . , CPn, such as the electronic component CP described above. The electrical connections CE of the electronic components CP1, . . . , CPn have a resistance which may vary among the various electronic components.

The integrated device DI also comprises measurement circuit MM configured to measure the resistance of the electrical connection CE of each electronic component CP1, . . . , CPn.

The integrated device further comprises a comparison circuit CM configured to compare the measured resistance of the electrical connection CE of each electronic component CP1, . . . , CPn with a reference resistance. The reference resistor can be formed by an electronic component CPr such as the electronic component CP described above.

The integrated device DI also comprises a generation circuit GM configured to generate a digital word DW from the results of the comparisons made by the comparison circuit.

The digital word DW that can be generated by the generation circuit GM comprises a plurality of bits.

In particular, the generation circuit GM is configured to attribute a value to each bit of the digital word DW depending on the results of the comparisons that can be carried out by the comparison circuit CM.

Thus, each bit of the digital word is associated with a given electronic component CP1, . . . , CPn, the value of this bit depending on the result of the comparison between the value of the resistance of the electrical connection CE of this electronic component and the reference resistance.

For example, the generation circuit GM is configured to attribute a value ‘0’ to a bit when the result of the comparison of the resistance of the electrical connection of the electronic component CP1, . . . , CPn associated with this bit and the reference resistance shows that the resistance of the electrical connection CE of the electronic component CP1, . . . , CPn used for this comparison is less than the reference resistance.

The generation circuit GM is then also configured to attribute a value ‘1’ to this bit when the result of said comparison shows that the value of the resistance of the electrical connection CE of the electronic component CP1, . . . , CPn is greater than the reference resistance.

The comparison circuit CM and the generation circuit GM can be implemented by a processing unit UT, such as a microprocessor.

The binary words DW that can thus be generated may then be used to develop encryption keys for example.

For example, an integrated device comprising 128 electronic components CP1, . . . , CPn can be used in order to obtain a 128-bit digital word DW.

1. A method for manufacturing an electronic component which includes source and drain regions, a gate region between the source and drain regions, and a dielectric lateral spacing region against a side of said gate region, the method comprising:
implanting ions in said dielectric lateral spacing region;
depositing a metal layer on the surface of said dielectric lateral spacing region as well as on the gate region and at least one of the source and drain regions;
applying a first heating to make the metal layer react with the gate region, said at least one of the source and drain regions, and the implanted ions in said dielectric lateral spacing region to form a silicide electrical connection extending over said dielectric lateral spacing region and configured to electrically connect the gate region to at least one of the source region and the drain region;
removing unreacted portions of said metal layer after the first heating; and
applying a second heating after removing the unreacted portions of said metal layer;
wherein said second heating is performed at a second temperature higher than a first temperature used for the first heating.

2. The method according to claim 1, wherein the first temperature is of the order of 300° C.

3. The method according to claim 2, wherein the second temperature is of the order of 400° C.

4. The method according to claim 1, wherein implanting comprises implanting an ion dose of that does not exceed 5×10¹³ ions/cm².

5. The method according to claim 1, wherein implanting comprises implanting an ion dose that does not exceed 2×10¹⁴ ions/cm².

6. The method according to claim 1, wherein implanting comprises implanting an ion dose that does not exceed 5×10¹⁵ ions/cm².

7. The method according to claim 1, wherein the electronic component is part of an integrated physical unclonable function device, the silicide electrical connection providing a current leakage path.

8. A method for manufacturing an electronic component which includes source and drain regions, a gate region between the source and drain regions, a first dielectric lateral spacing region against a first side of said gate region between the gate region and source region, and a second dielectric lateral spacing region against a second side of said gate region between the gate region and drain region, the method comprising:
forming an electrical connection comprising a silicide on a surface of both the first and second dielectric lateral spacing regions, said electrical connecting configured to electrically connect the gate region to both the source region and the drain region.

9. The method according to claim 8, wherein forming said electrical connection comprises:
implanting ions in the first and second dielectric lateral spacing regions;
depositing a metal layer on the surface of the first and second dielectric lateral spacing regions; and
performing a silicidation by said metal layer to form, by reaction of said metal layer with the implanted ions, said electrical connection.

10. The method according to claim 9, wherein depositing further comprises depositing said metal layer also on the source, drain and gate regions.

11. The method according to claim 9, wherein performing the silicidation comprises:
applying a first heating at a first temperature;
removing unreacted portions of said metal layer after the first heating; and
applying a second heating at a second temperature;
wherein said second temperature is higher than said first temperature.

12. The method according to claim 11, wherein the first temperature is of the order of 300° C.

13. The method according to claim 12, wherein the second temperature is of the order of 400° C.

14. The method according to claim 9, wherein implanting comprises implanting an ion dose that does not exceed 5×10¹³ ions/cm².

15. The method according to claim 9, wherein implanting comprises implanting an ion dose that does not exceed 2×10¹⁴ ions/cm².

16. The method according to claim 9, wherein implanting comprises implanting an ion dose that does not exceed 5×10¹⁵ ions/cm².

17. The method according to claim 9, wherein the electronic component is part of an integrated physical unclonable function device, the silicide electrical connection providing a current leakage path.

18. An integrated physical unclonable function device, comprising:
a plurality of electronic components, wherein each electronic component comprises:
source and drain regions;
a gate region between the source and drain regions;
two dielectric lateral spacing regions against sides of the gate region; and
an electrical connection on a surface of at least one of said two dielectric lateral spacing regions, said electrical connection configured to electrically connect the gate region to at least one of the source region and the drain region;
wherein each electrical connection has a resistance;
a resistance measuring circuit configured to measure the resistance of said electrical connection of each electronic component;
a comparison circuit configured to compare the measured resistance of said electrical connection of each electronic component with a given reference resistance; and
a generation circuit configured to generate a digital word in response to the comparisons made by the comparison circuit.

19. The device according to claim 18, wherein the electrical connection on the surface is a silicide.
